(19) United States
(12) Patent Application Publication
(10) Pub. No.: US 2020/0312189 A1
(43) Pub. Date: Oct. 1, 2020

(54) LEARNING KITS

(71) Applicant: Joulez, Inc., Cambridge, MA (US)

(72) Inventor: Stephanie Rowe, Cambridge, MA (US)

(73) Assignee: Joulez, Inc., Cambridge, MA (US)

(21) Appl. No.: 16/368,471

(22) Filed: Mar. 28, 2019

(51) Int. Cl. G09B 23/00

(52) U.S. Cl. CPC G09B 23/00

(57) ABSTRACT

STEAM learning kits can include interactive devices that can be assembled by users. The interactive devices can have various designs and features that facilitate learning by users. The STEAM learning kits can be used to assemble interactive devices that can take on a number of forms that would be interesting for a child's toy, including but not limited to insects, animals, vehicles, or other figures. Various aspects of the present disclosure describe examples of systems that include interactive devices implemented in an interactive device form factor, such as to enable a user to assemble a butterfly wall; features of various examples described herein can be used to implement various form factors of interactive devices.

### BACKGROUND

The present disclosure relates generally to the field of Internet of Things (IoT) devices. More particularly, the present disclosure relates to systems and methods for an IoT connected science, technology, engineering, art, and math (“STEAM”) learning kit.

Educational devices, including toys and kits that can be assembled by users, can enable users to develop helpful hands-on skills and learning approaches. Such devices can have mechanical and electrical components intended to be assembled together in a manner that teaches users the skills associated with the assembly and knowledge of the components.

### SUMMARY

According to various aspects of the present disclosure, STEAM learning kits can include interactive devices that can be assembled by users. The interactive devices can have various designs and features that facilitate learning by users. The STEAM learning kits can be used to assemble interactive devices that can take on a number of forms that would be interesting for a child's toy, including but not limited to insects, animals, vehicles, or other figures. Various aspects of the present disclosure describe examples of systems that include interactive devices implemented in an interactive device form factor, such as to enable a user to assemble a butterfly wall; features of various examples described herein can be used to implement various form factors of interactive devices.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE FIGURES

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of examples of learning kits and interactive devices thereof according to an implementation of the present disclosure.

FIG. 2 is a schematic diagram of examples of learning kits and interactive devices thereof according to an implementation of the present disclosure.

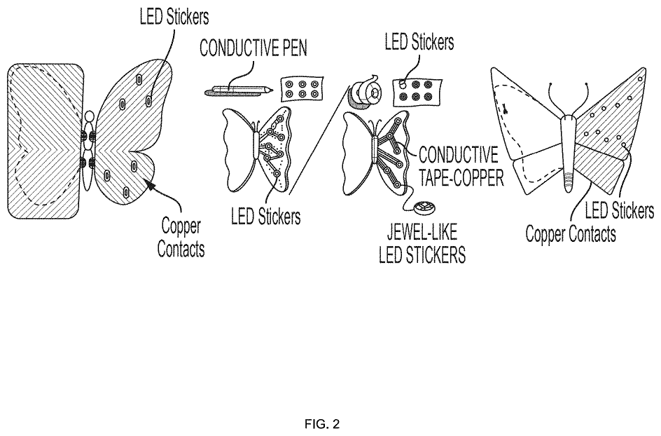

FIG. 3 is a schematic diagram of examples of learning kits and interactive devices thereof according to an implementation of the present disclosure.

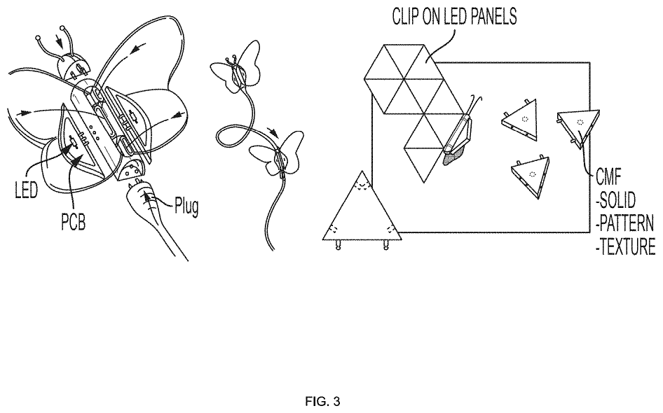

FIG. 4 is a schematic diagram of examples of learning kits and interactive devices thereof according to an implementation of the present disclosure.

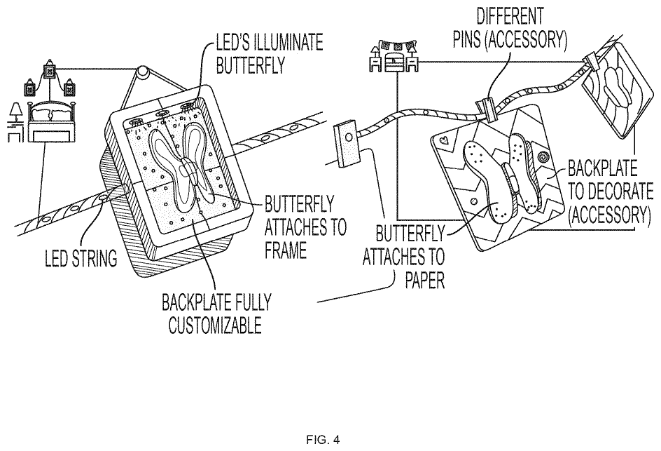

FIG. 5 is a schematic diagram of examples of learning kits and interactive devices thereof according to an implementation of the present disclosure.

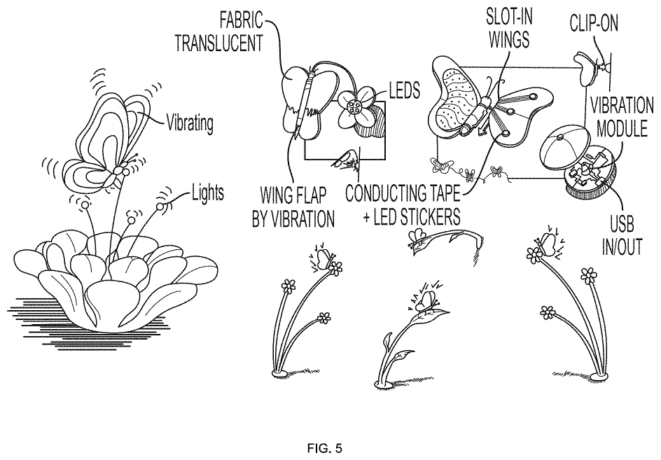

FIG. 6 is a schematic diagram of examples of learning kits and interactive devices thereof according to an implementation of the present disclosure.

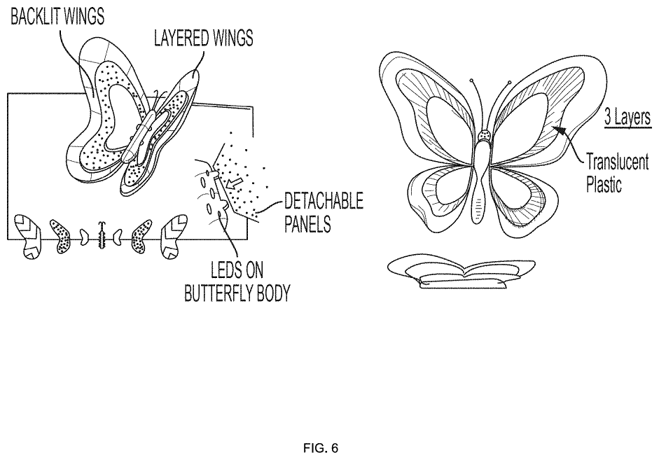

FIG. 7 is a schematic diagram of examples of learning kits and interactive devices thereof according to an implementation of the present disclosure.

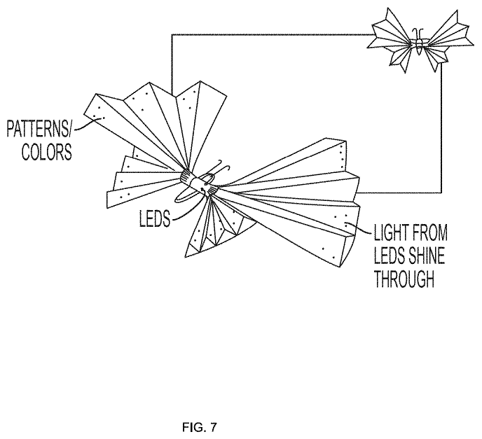

FIG. 8 is a schematic diagram of examples of learning kits and interactive devices thereof according to an implementation of the present disclosure.

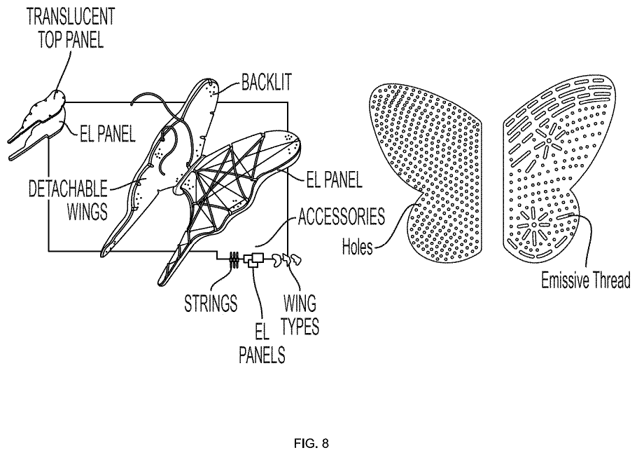

FIG. 9 is a schematic diagram of examples of learning kits and interactive devices thereof according to an implementation of the present disclosure.

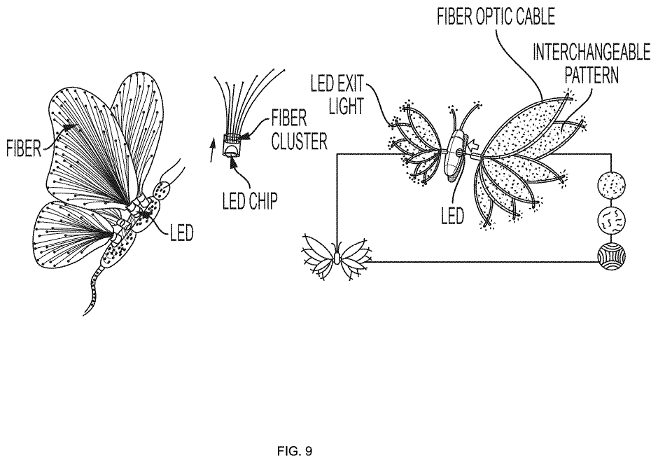

FIG. 10 is a schematic diagram of an example of a learning kit and interactive devices thereof according to an implementation of the present disclosure.

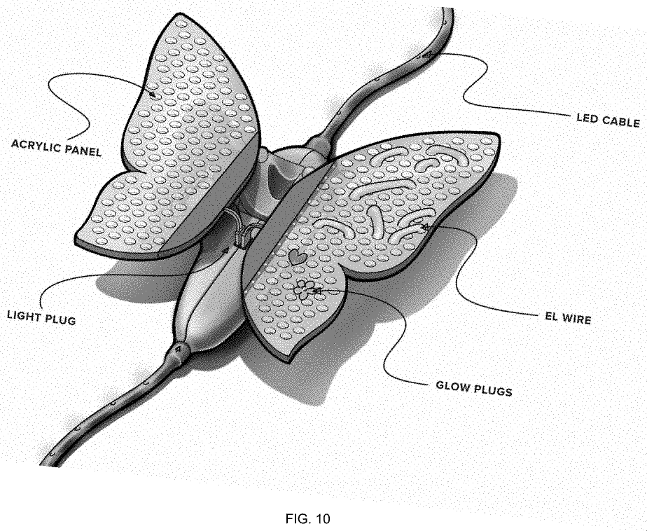

FIG. 11 is a schematic diagram of examples of learning kits and interactive devices thereof according to an implementation of the present disclosure.

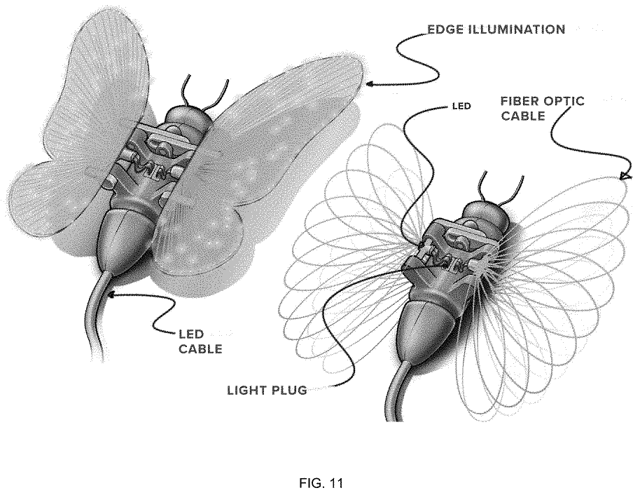

FIG. 12 is a schematic diagram of an example of a learning kit and interactive devices thereof according to an implementation of the present disclosure.

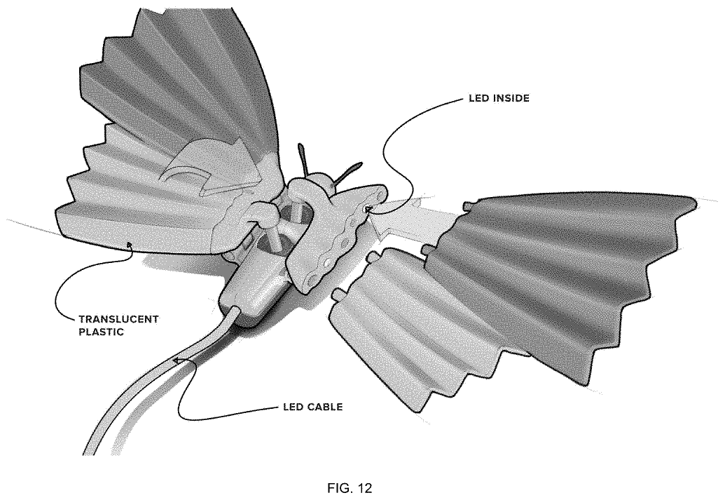

FIG. 13 is a schematic diagram of an example of a learning kit and interactive devices thereof according to an implementation of the present disclosure.

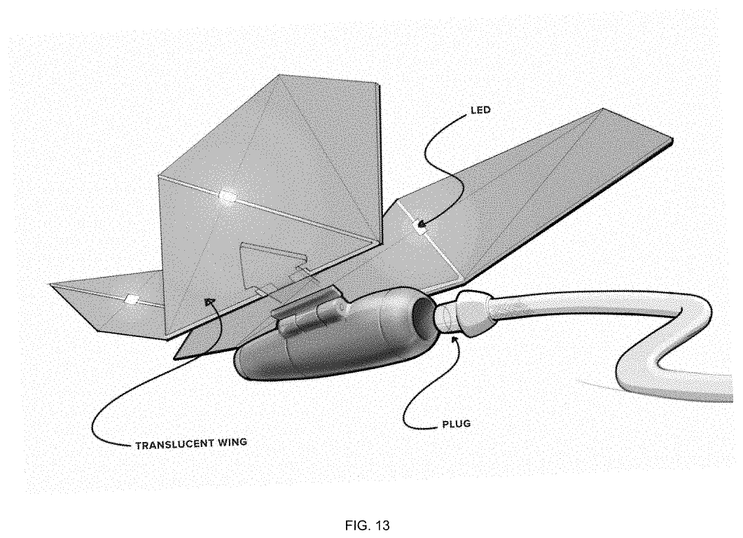

FIG. 14 is a schematic diagram of an example of a learning kit and interactive devices thereof according to an implementation of the present disclosure.

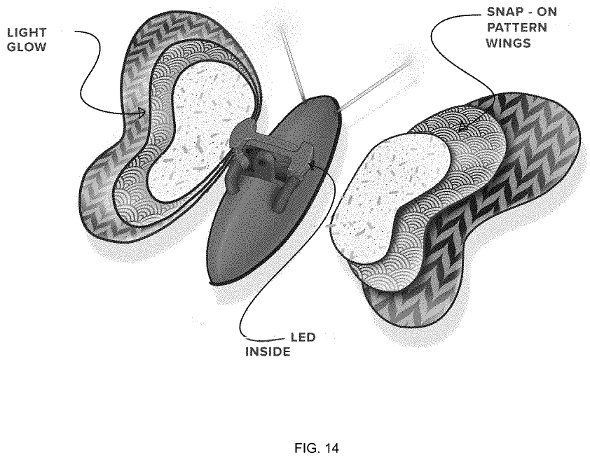

FIG. 15 is a schematic diagram of an example of a learning kit and interactive devices thereof according to an implementation of the present disclosure.

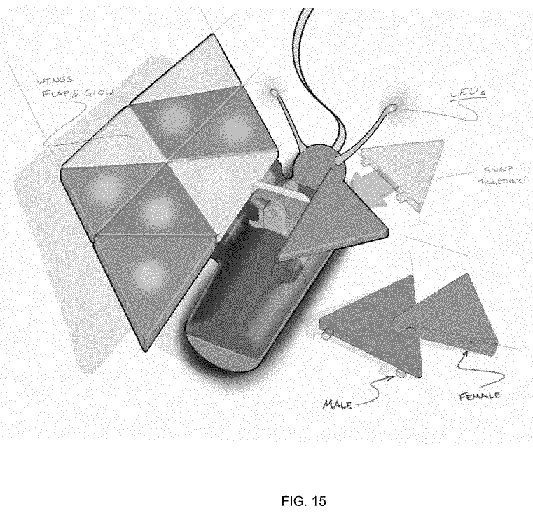

FIG. 16 is a schematic diagram of examples of learning kits and interactive devices thereof according to an implementation of the present disclosure.

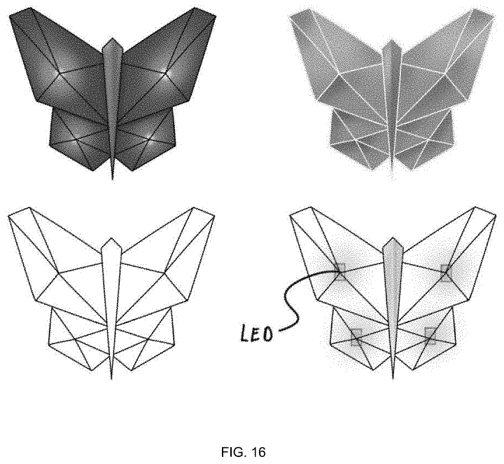

FIG. 17 is a schematic diagram of examples of learning kits and interactive devices thereof according to an implementation of the present disclosure.

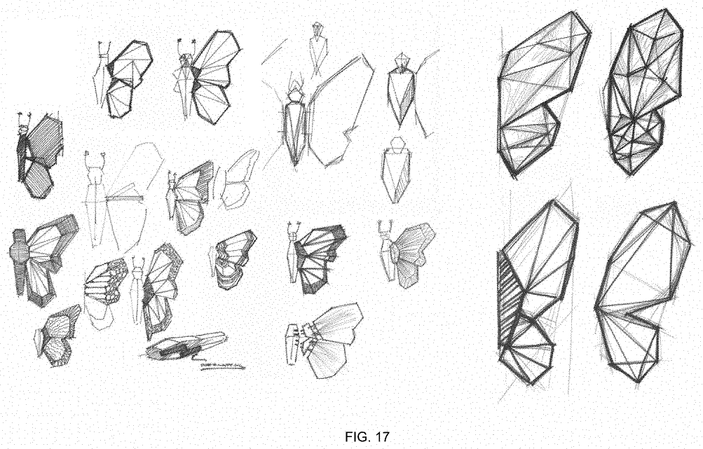

FIG. 18 is a schematic diagram of examples of learning kits and interactive devices thereof according to an implementation of the present disclosure.

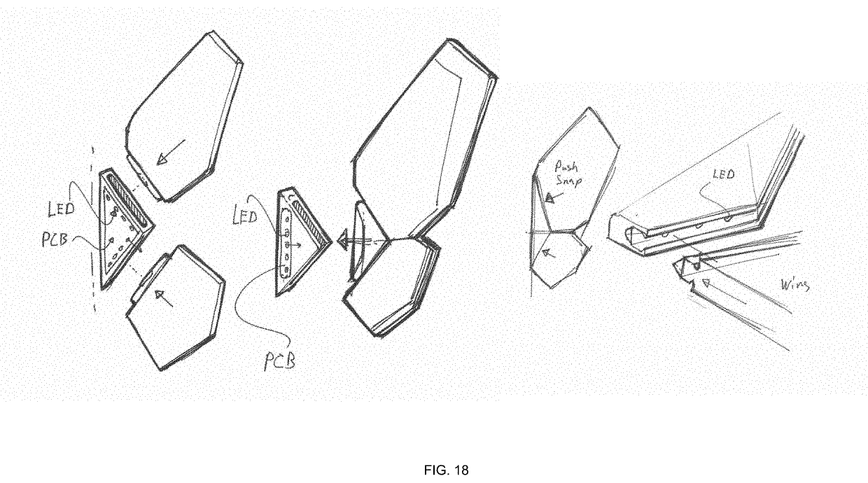

FIG. 19 is a schematic diagram of examples of learning kits and interactive devices thereof according to an implementation of the present disclosure.

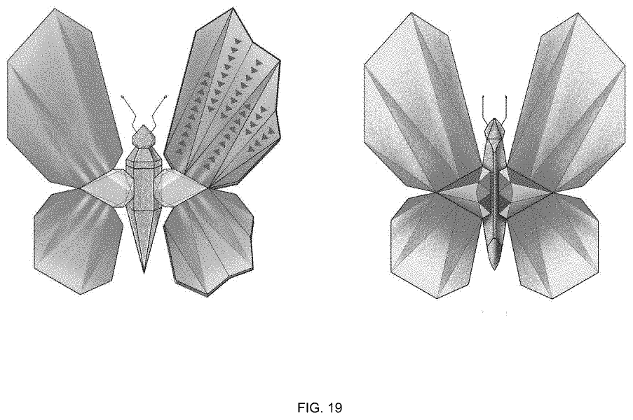

FIG. 20 is a schematic diagram of examples of learning kits and interactive devices thereof according to an implementation of the present disclosure.

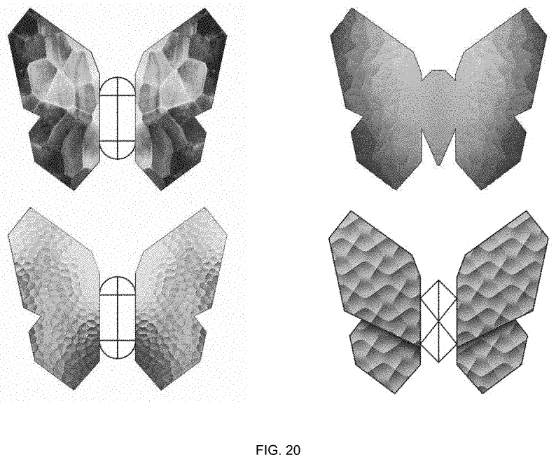

FIG. 21 is a schematic diagram of examples of learning kits and interactive devices thereof according to an implementation of the present disclosure.

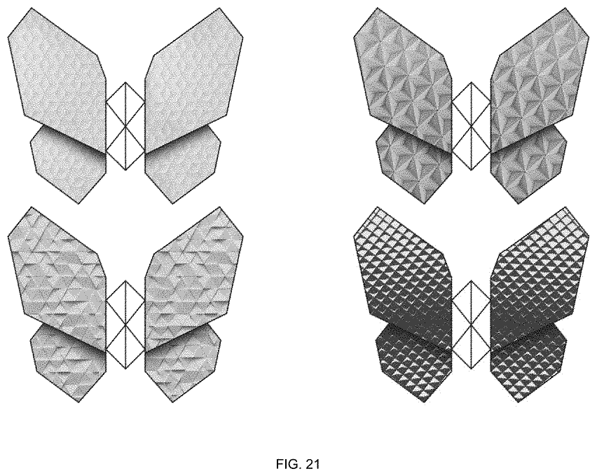

FIG. 22 is a schematic diagram of examples of learning kits and interactive devices thereof according to an implementation of the present disclosure.

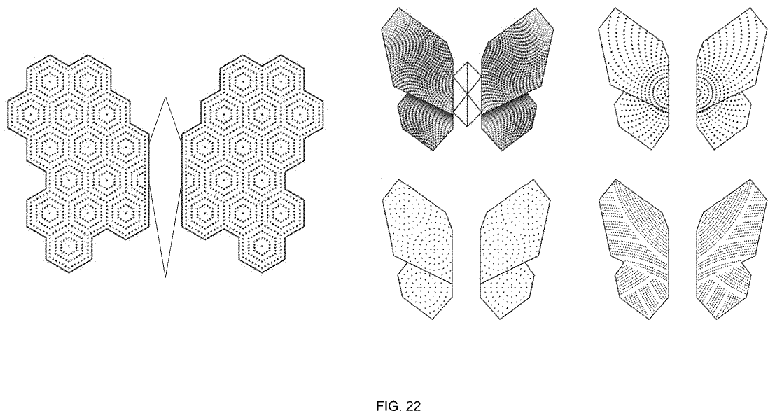

FIG. 23 is a schematic diagram of examples of learning kits and interactive devices thereof according to an implementation of the present disclosure.

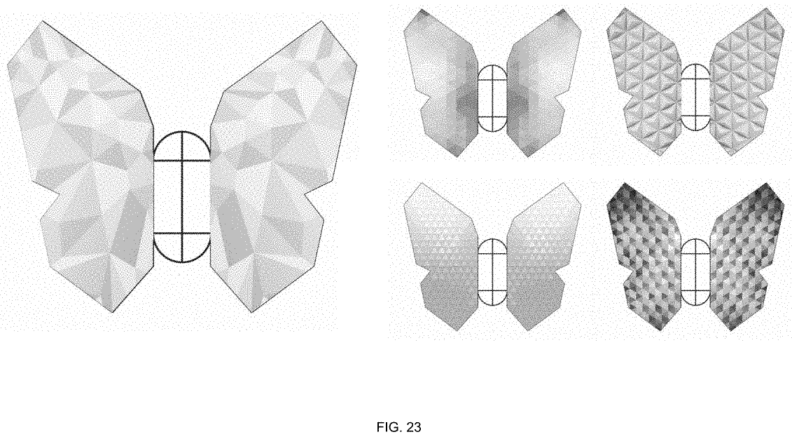

FIG. 24 is a schematic diagram of examples of learning kits and interactive devices thereof according to an implementation of the present disclosure.

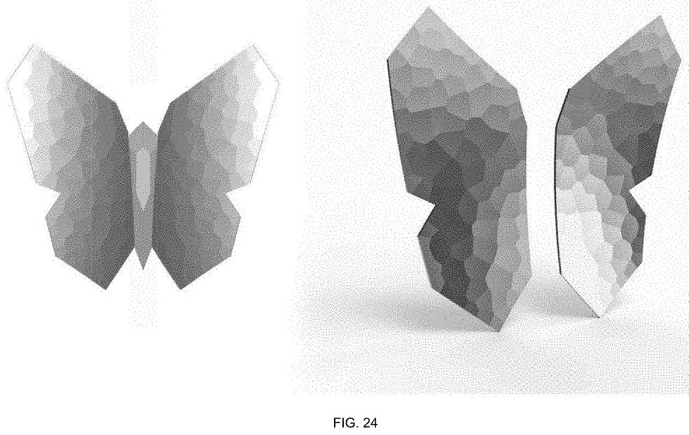

FIG. 25 is a schematic diagram of examples of learning kits and interactive devices thereof according to an implementation of the present disclosure.

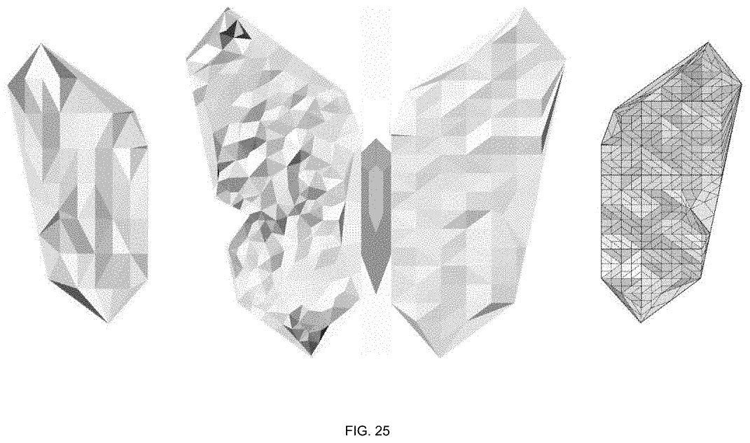

FIG. 26 is a schematic diagram of examples of learning kits and interactive devices thereof according to an implementation of the present disclosure.

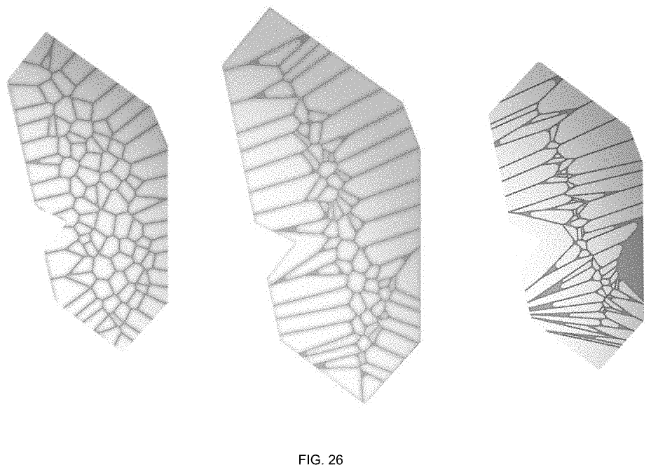

FIG. 27 is a schematic diagram of examples of learning kits and interactive devices thereof according to an implementation of the present disclosure.

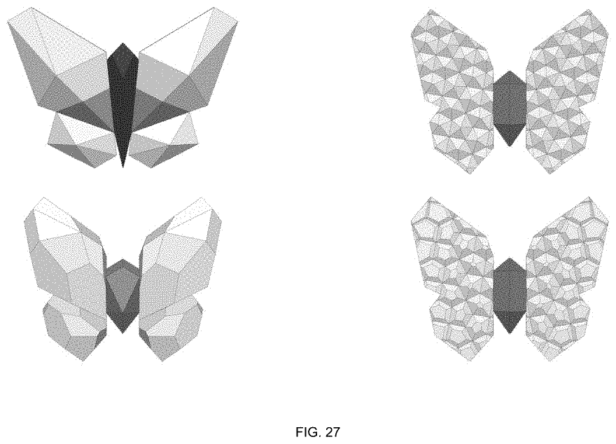

FIG. 28 is a schematic diagram of examples of learning kits and interactive devices thereof according to an implementation of the present disclosure.

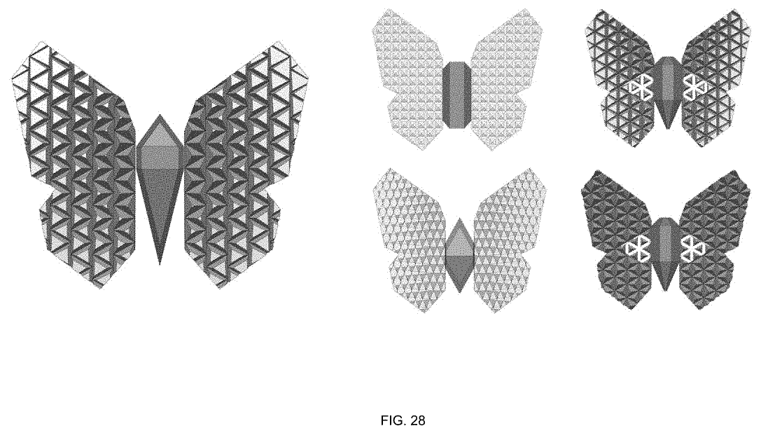

FIG. 29 is a schematic diagram of examples of learning kits and interactive devices thereof according to an implementation of the present disclosure.

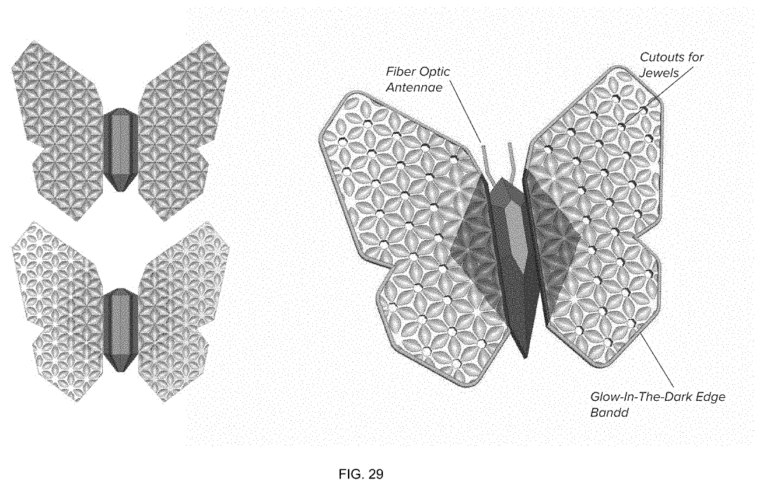

FIG. 30 is a schematic diagram of examples of learning kits and interactive devices thereof according to an implementation of the present disclosure.

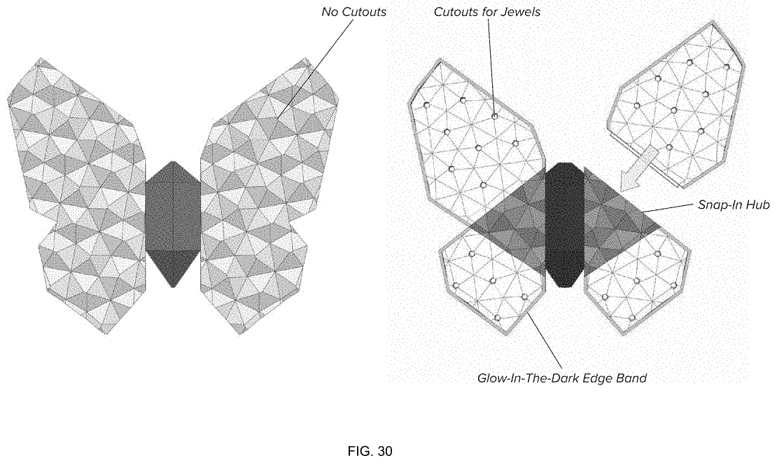

FIG. 31 is a schematic diagram of examples of learning kits and interactive devices thereof according to an implementation of the present disclosure.

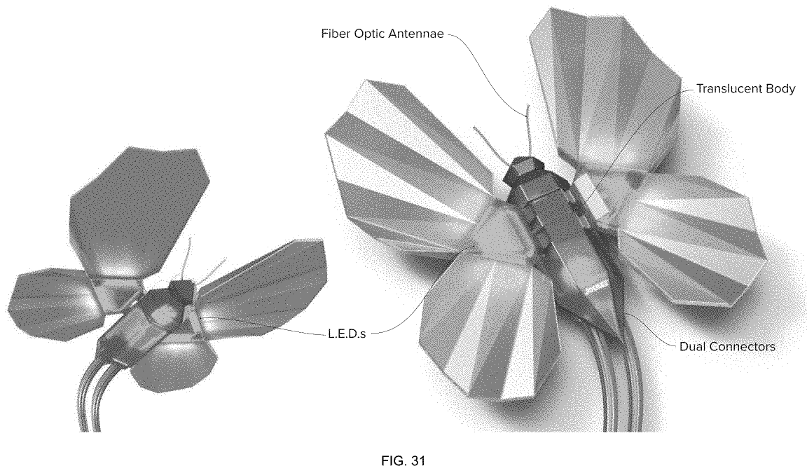

FIG. 32 is a schematic diagram of examples of learning kits and interactive devices thereof according to an implementation of the present disclosure.

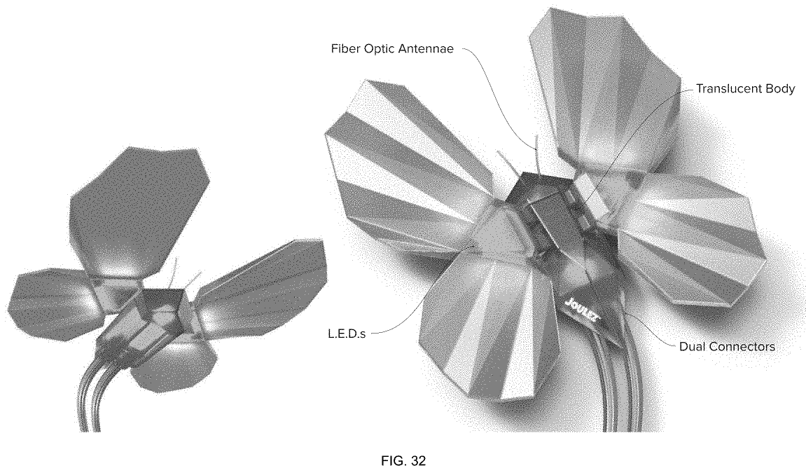

FIG. 33 is a schematic diagram of examples of learning kits and interactive devices thereof according to an implementation of the present disclosure.

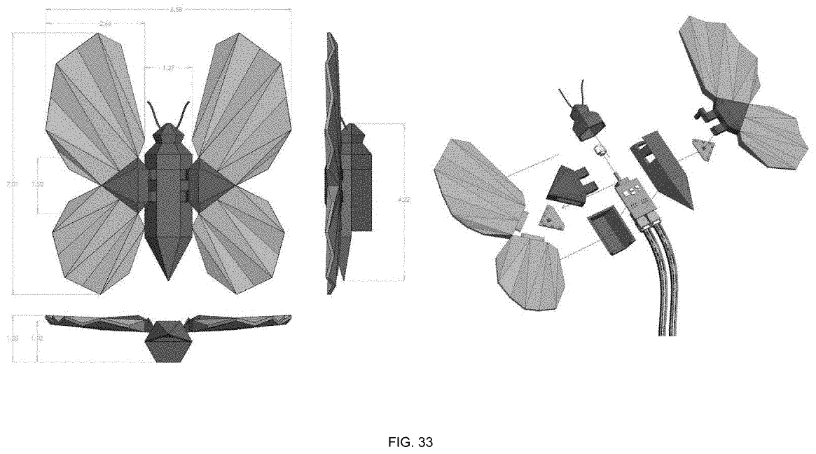

FIG. 34 is a schematic diagram of examples of learning kits and interactive devices thereof according to an implementation of the present disclosure.

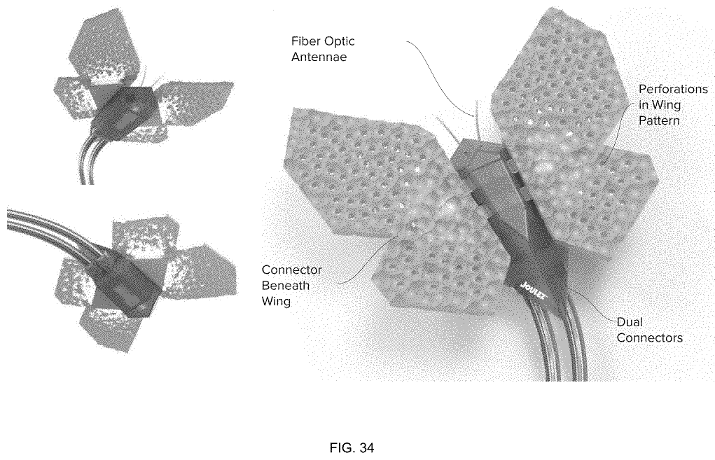

FIG. 35 is a schematic diagram of examples of learning kits and interactive devices thereof according to an implementation of the present disclosure.

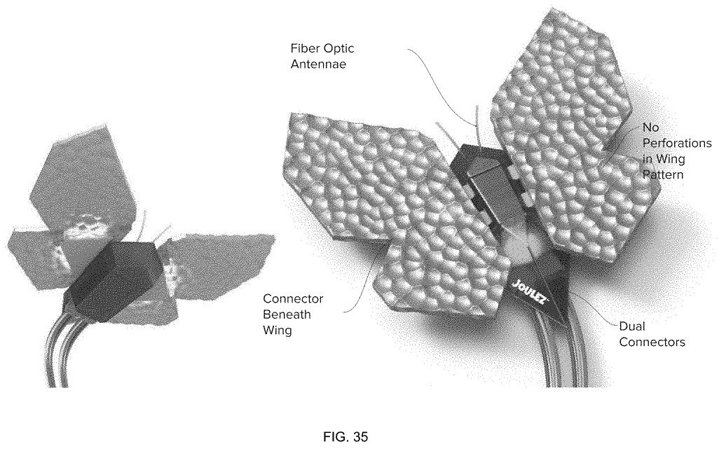

FIG. 36 is a schematic diagram of examples of learning kits and interactive devices thereof according to an implementation of the present disclosure.

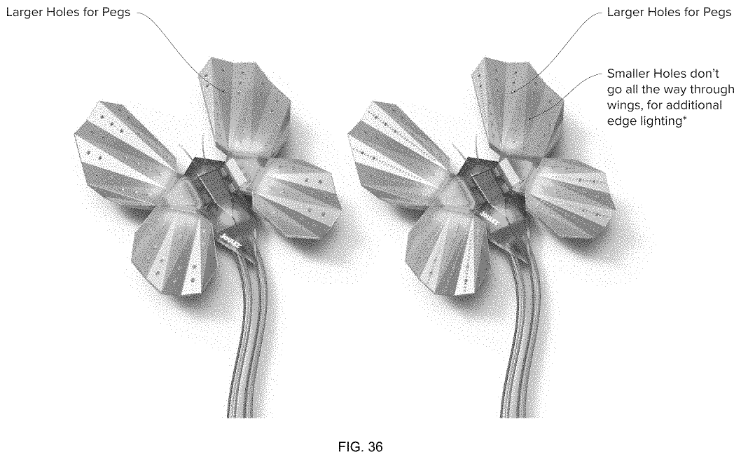

FIG. 37 is a schematic diagram of examples of devices that can be used with learning kits according to an implementation of the present disclosure.

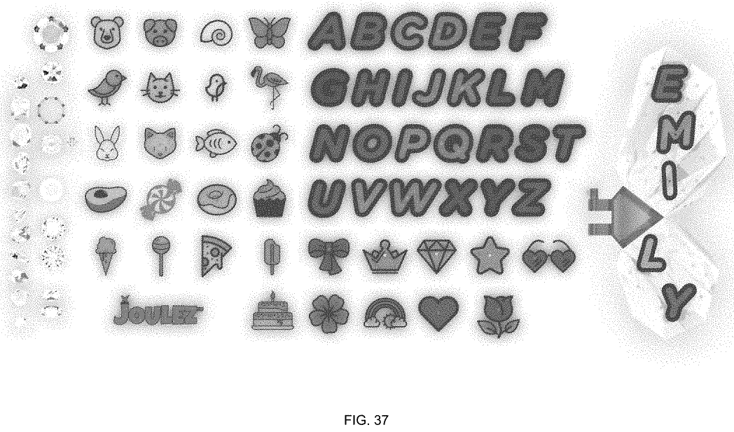

FIG. 38 is a schematic diagram of examples of devices that can be used with learning kits according to an implementation of the present disclosure.

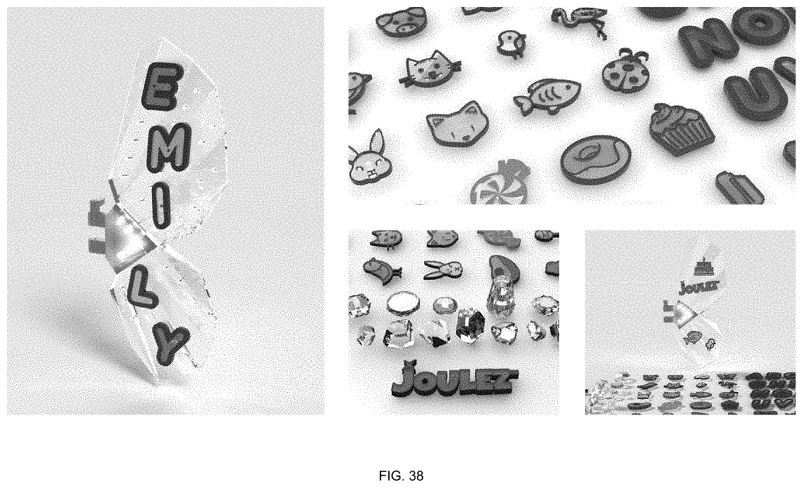

FIG. 39 is a schematic diagram of an example of a learning kit and interactive devices thereof according to an implementation of the present disclosure.

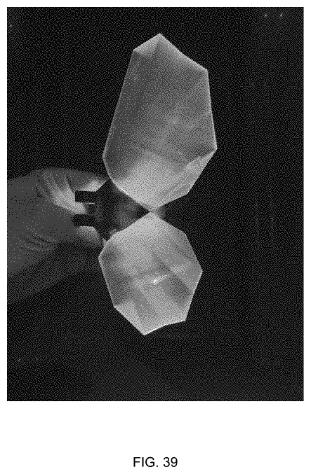

FIG. 40 is a schematic diagram of examples of learning kits and interactive devices thereof according to an implementation of the present disclosure.

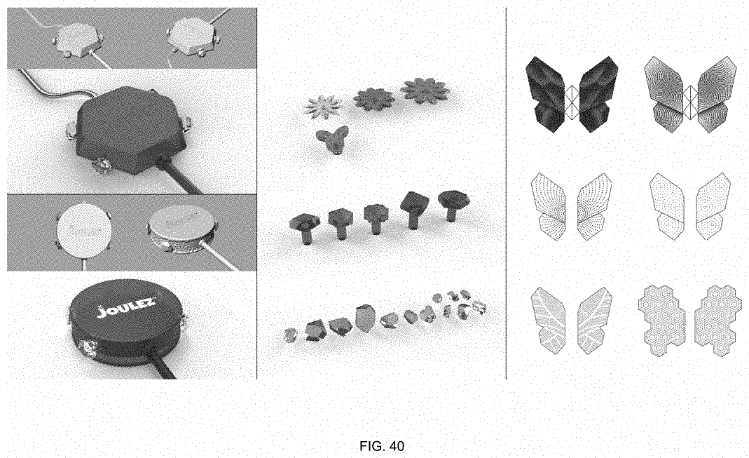

FIG. 41 is a schematic diagram of examples of learning kits and interactive devices thereof according to an implementation of the present disclosure.

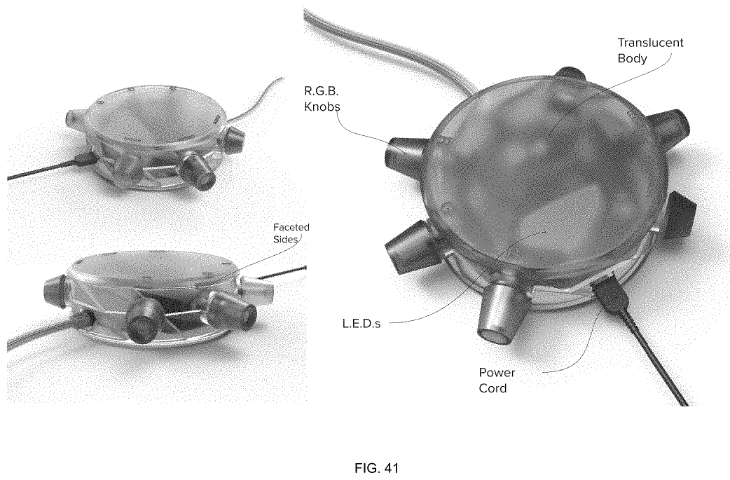

FIG. 42 is a schematic diagram of an example of a learning kit and interactive devices thereof according to an implementation of the present disclosure.

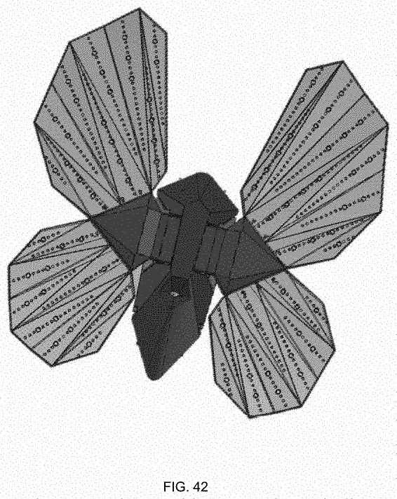

FIG. 43 is a schematic diagram of an example of a learning kit and interactive devices thereof according to an implementation of the present disclosure.

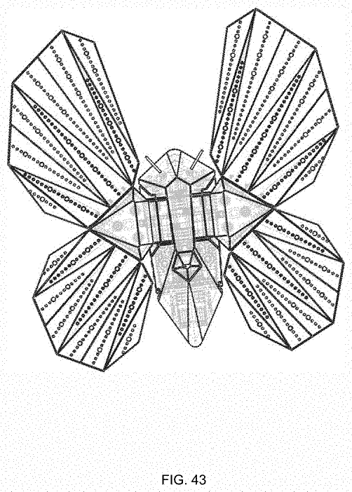

FIG. 44 is a schematic diagram of an example of a learning kit and interactive devices thereof according to an implementation of the present disclosure.

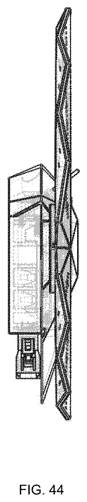

FIG. 45 is a schematic diagram of an example of a learning kit and interactive devices thereof according to an implementation of the present disclosure.

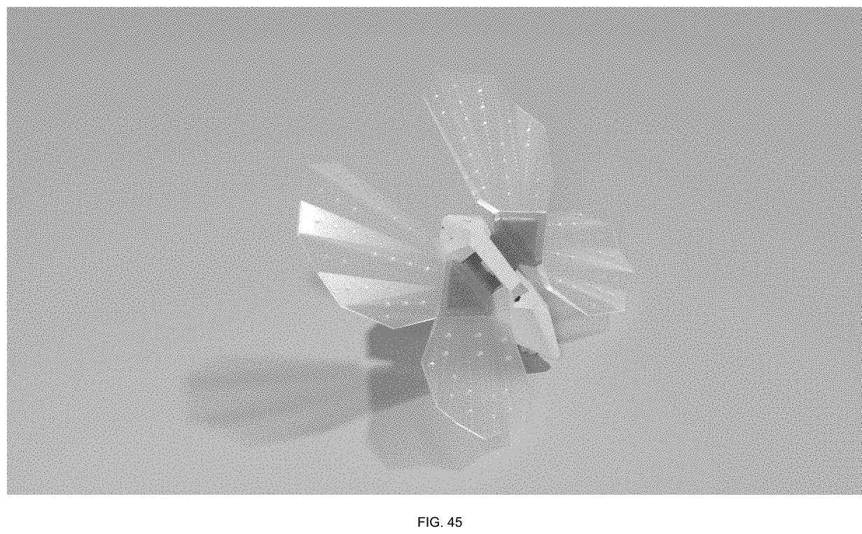

FIG. 46 is a schematic diagram of an example of a learning kit and interactive devices thereof according to an implementation of the present disclosure.

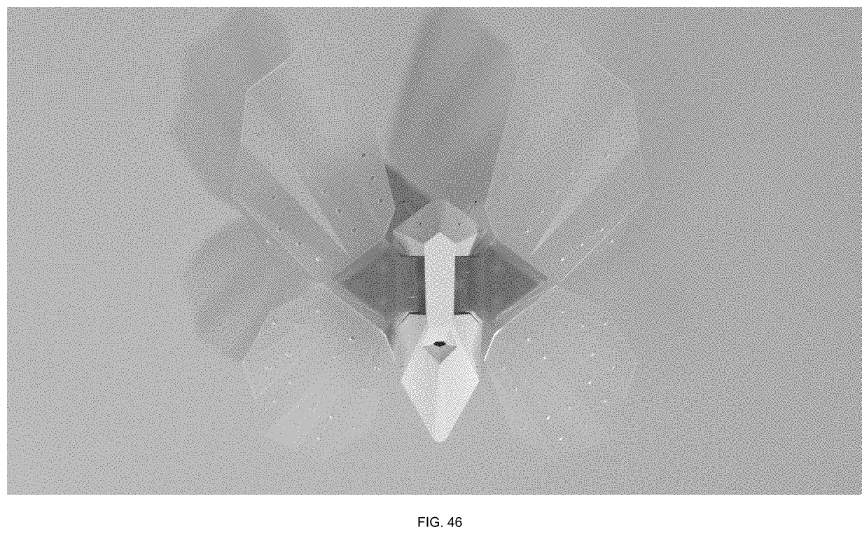

FIG. 47 is a schematic diagram of an example of a learning kit and interactive devices thereof according to an implementation of the present disclosure.

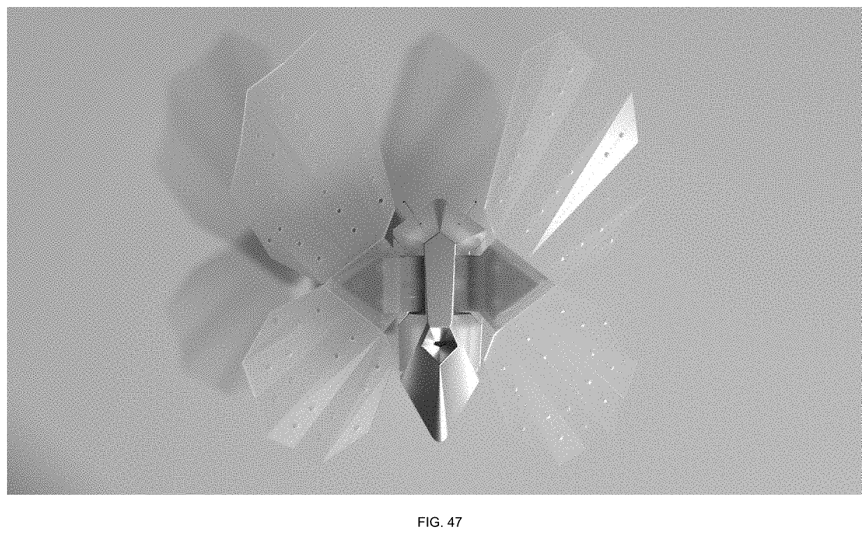

FIG. 48 is a schematic diagram of an example of a learning kit and interactive devices thereof according to an implementation of the present disclosure.

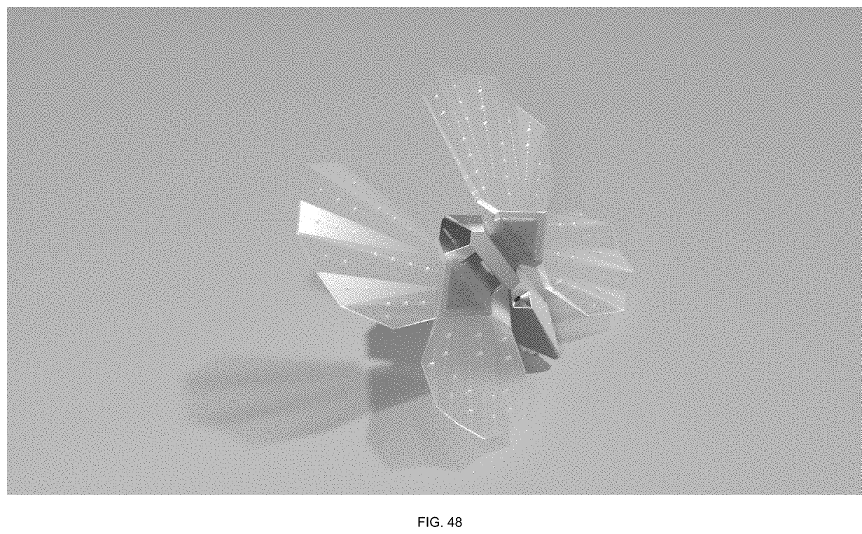

FIG. 49 is a schematic diagram of an example of a learning kit and interactive devices thereof according to an implementation of the present disclosure.

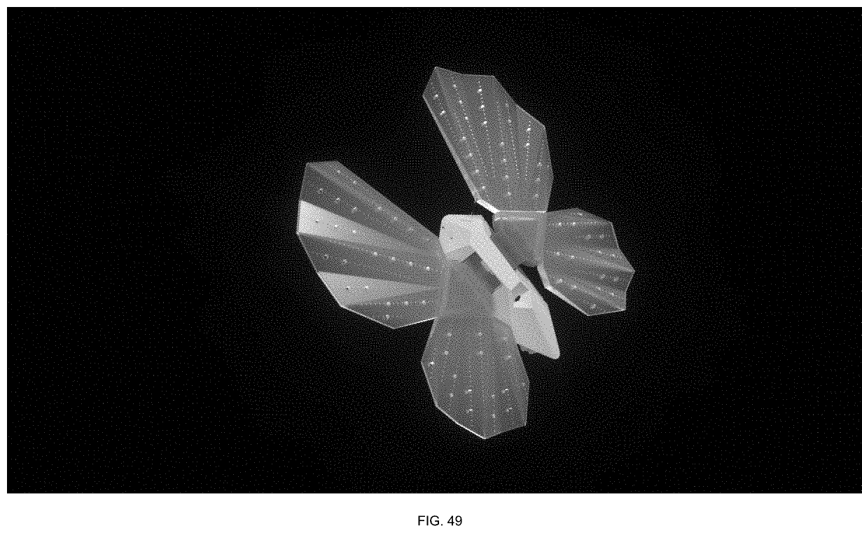

FIG. 50 is a schematic diagram of an example of a learning kit and interactive devices thereof according to an implementation of the present disclosure.

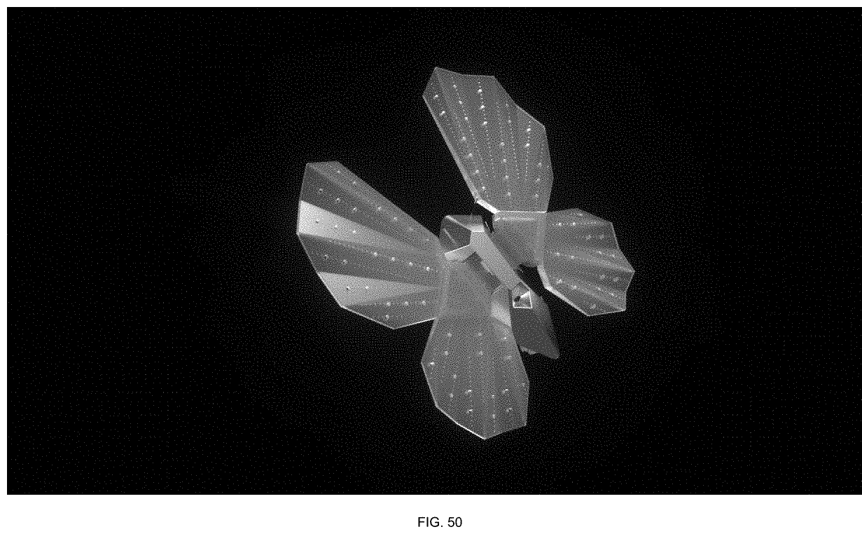

FIG. 51 is a schematic diagram of examples of learning kits and interactive devices thereof according to an implementation of the present disclosure.

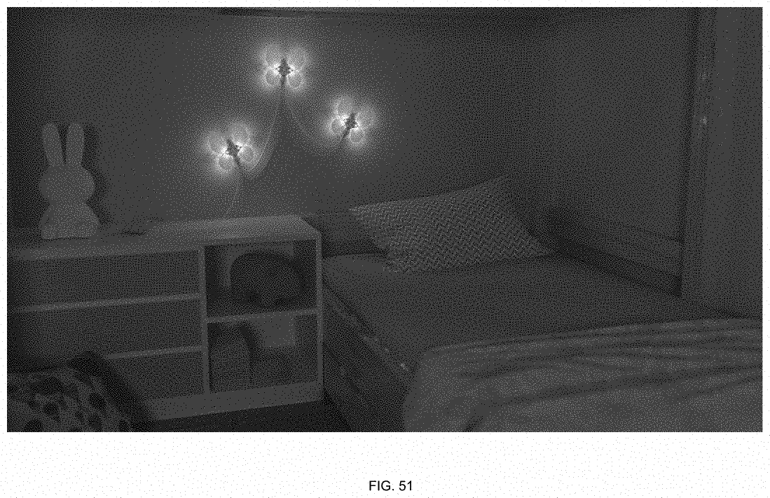

FIG. 52 is a schematic diagram of examples of learning kits and interactive devices thereof according to an implementation of the present disclosure.

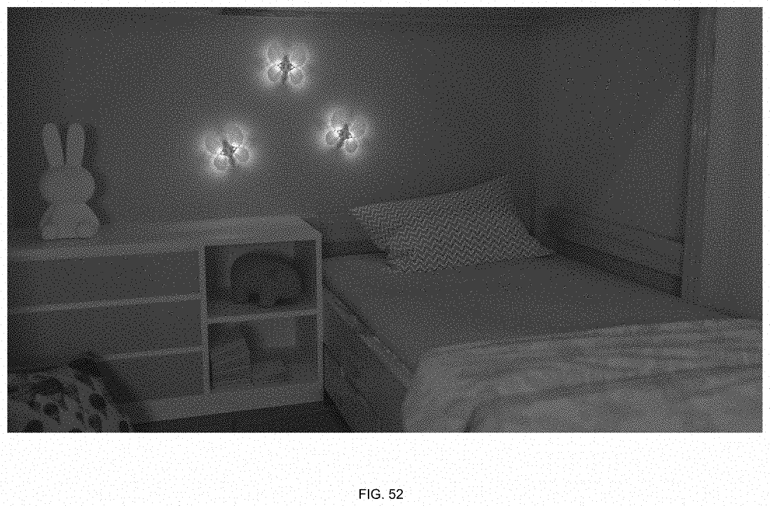

FIG. 53 is a schematic diagram of examples of devices that can be used with learning kits thereof according to an implementation of the present disclosure.

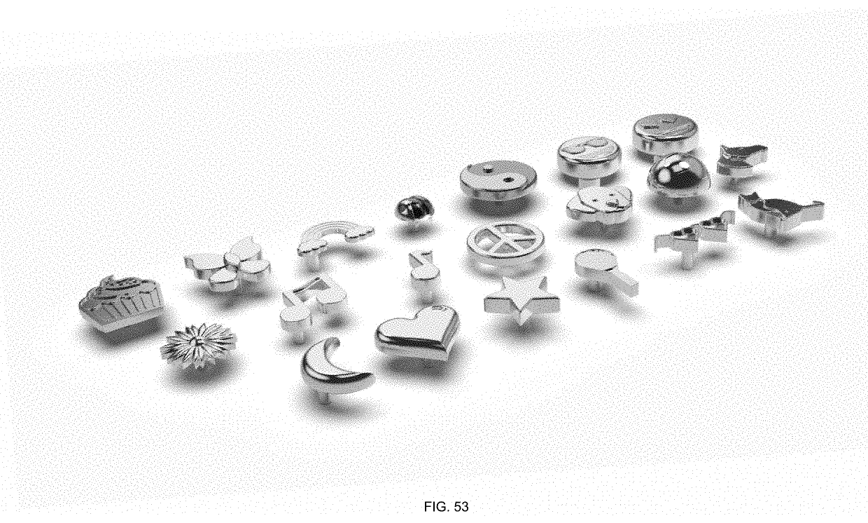

FIG. 54 is a schematic diagram of examples of devices that can be used with learning kits according to an implementation of the present disclosure.

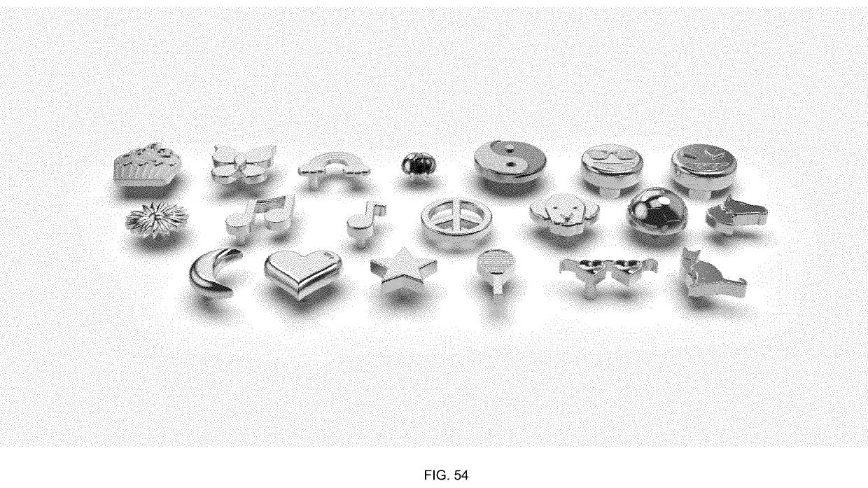

FIG. 55 is a schematic diagram of examples of learning kits and interactive devices thereof according to an implementation of the present disclosure.

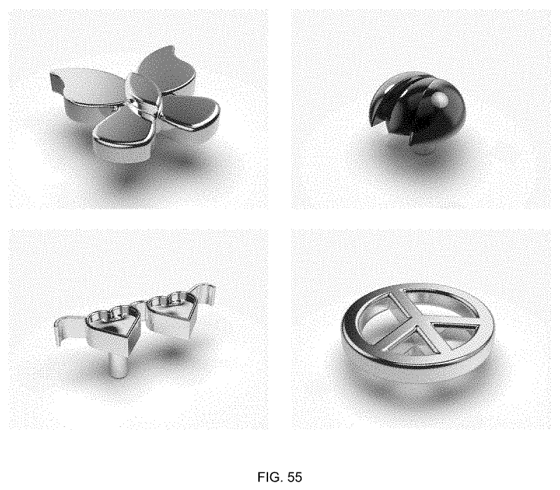

FIG. 56 is a schematic diagram of examples of devices that can be used with learning kits according to an implementation of the present disclosure.

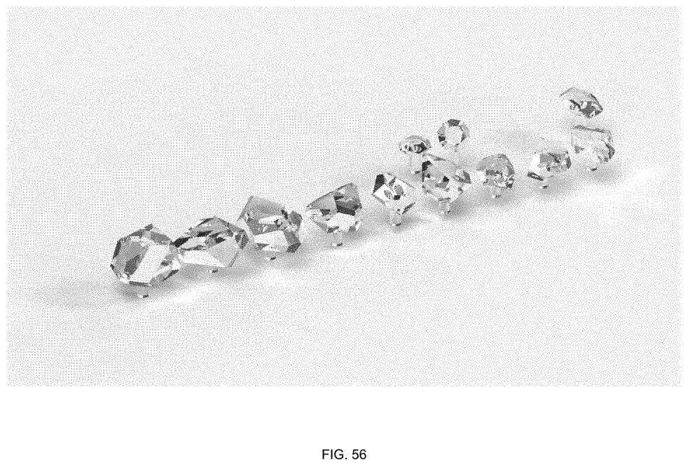

FIG. 57 is a schematic diagram of examples of learning kits and interactive devices thereof according to an implementation of the present disclosure.

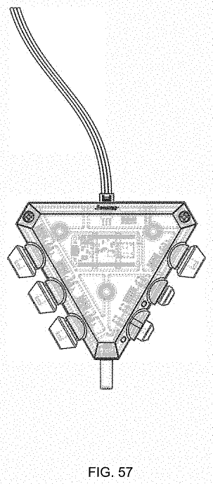

FIG. 58 is a schematic diagram of an example of a hub of an interactive device that can be used in a learning kit according to an implementation of the present disclosure.

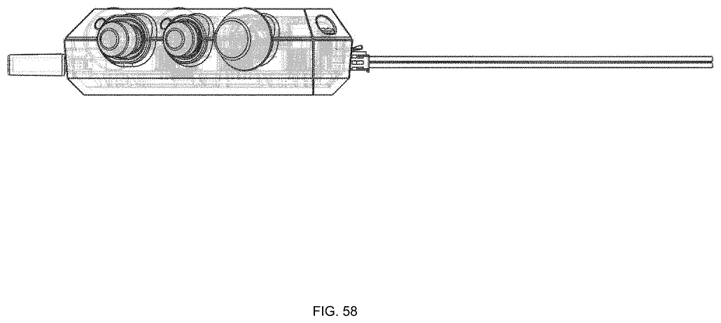

FIG. 59 is a schematic diagram of an example of a hub of an interactive device that can be used in a learning kit according to an implementation of the present disclosure.

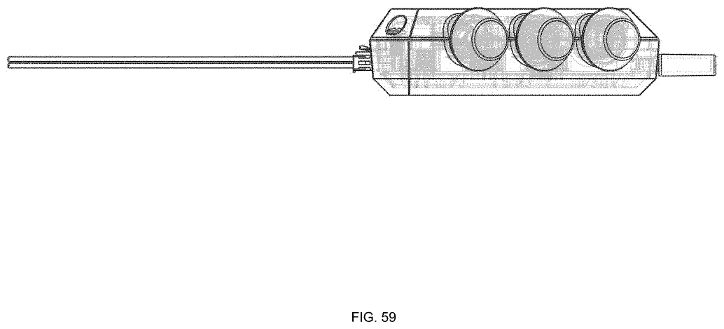

FIG. 60 is a schematic diagram of an example of a hub of an interactive device that can be used in a learning kit according to an implementation of the present disclosure.

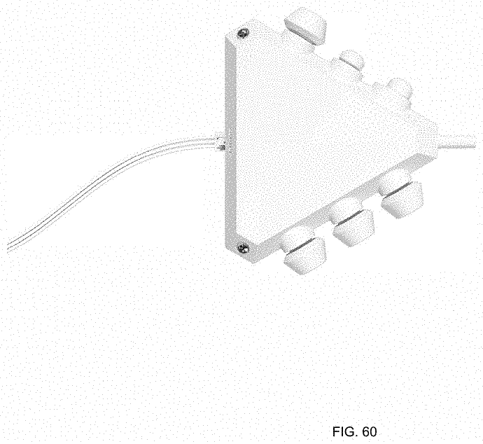

FIG. 61 is a schematic diagram of an example of a hub of an interactive device that can be used in a learning kit according to an implementation of the present disclosure.

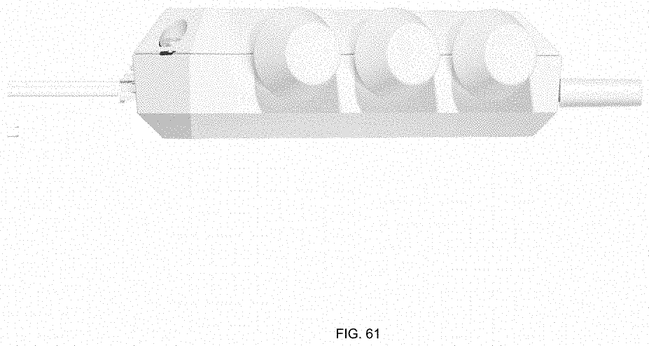

FIG. 62 is a schematic diagram of examples of a hub of an interactive device that can be used in a learning kit according to an implementation of the present disclosure.

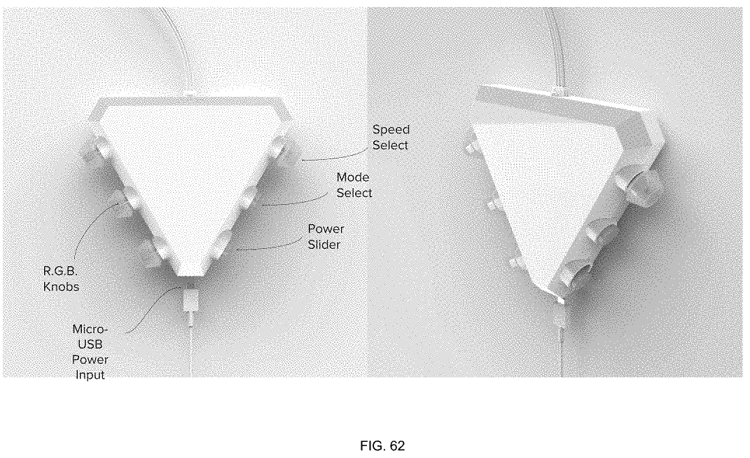

FIG. 63 is a schematic diagram of examples of a hub of an interactive device that can be used in a learning kit according to an implementation of the present disclosure.

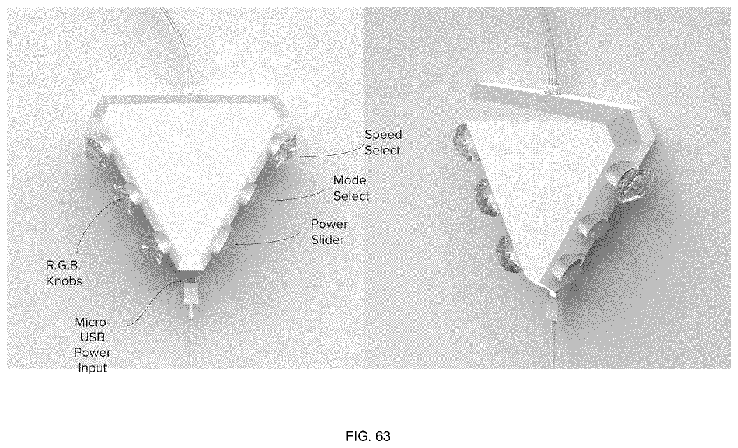

FIG. 64 is a schematic diagram of examples of learning kits and interactive devices thereof according to an implementation of the present disclosure.

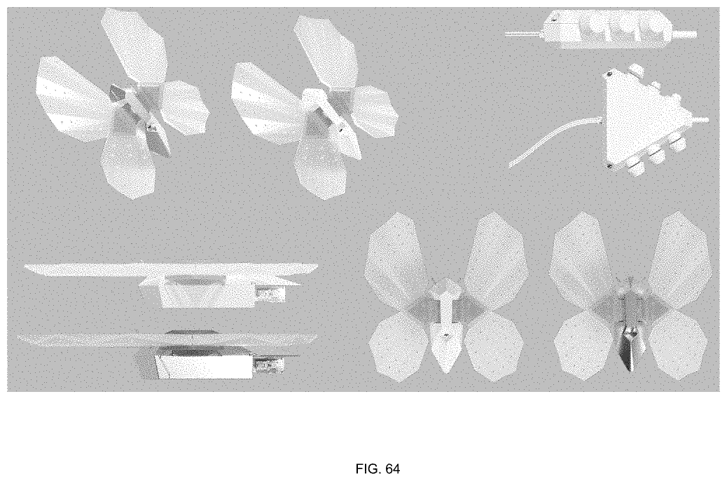

FIG. 65 is a schematic diagram of examples of learning kits and interactive devices thereof according to an implementation of the present disclosure.

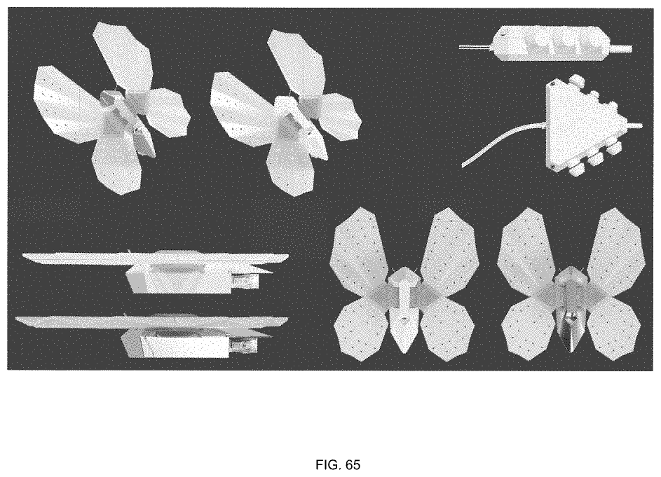

FIG. 66 is a schematic diagram of examples of learning kits and interactive devices thereof according to an implementation of the present disclosure.

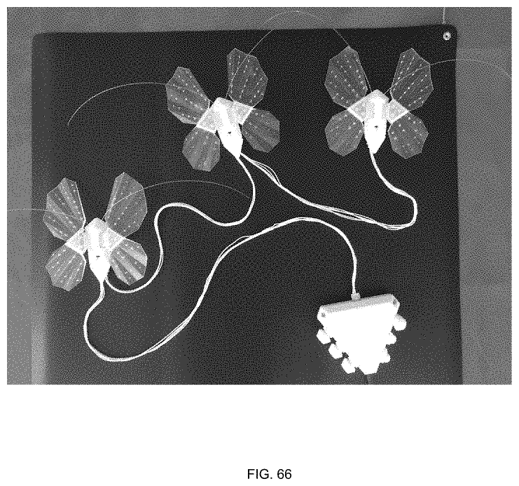

FIG. 67 is a schematic diagram of an example of a learning kit and interactive devices thereof according to an implementation of the present disclosure.

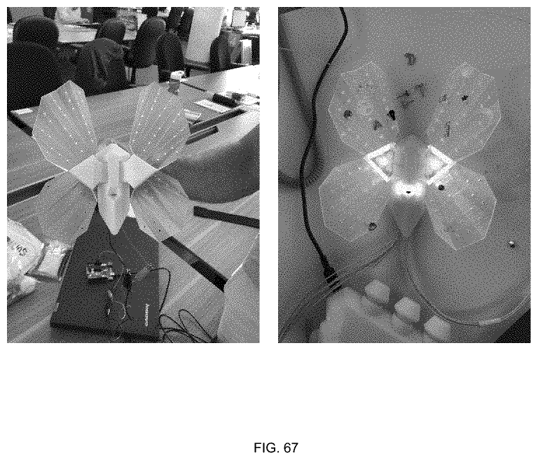

FIG. 68 is a schematic diagram of an example of a learning kit and interactive devices thereof according to an implementation of the present disclosure.

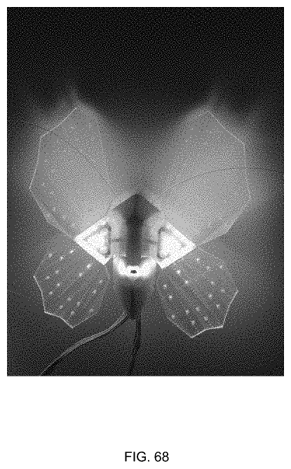

FIG. 69 is a schematic diagram of an example of a learning kit and interactive devices thereof according to an implementation of the present disclosure.

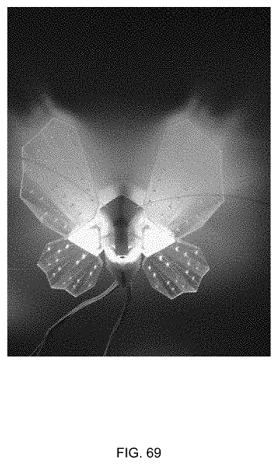

FIG. 70 is a schematic diagram of an example of a learning kit and interactive devices thereof according to an implementation of the present disclosure.

### DETAILED DESCRIPTION

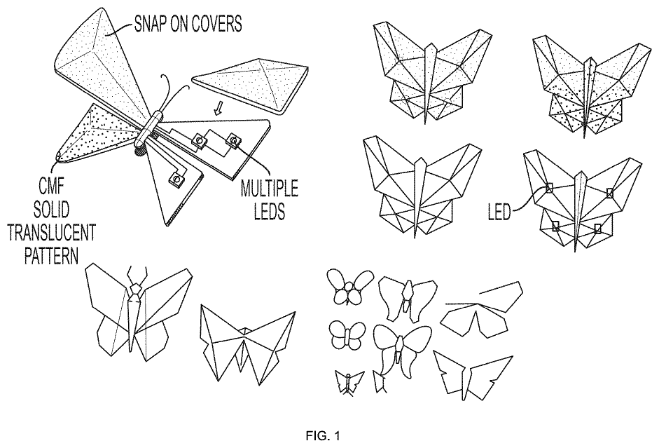

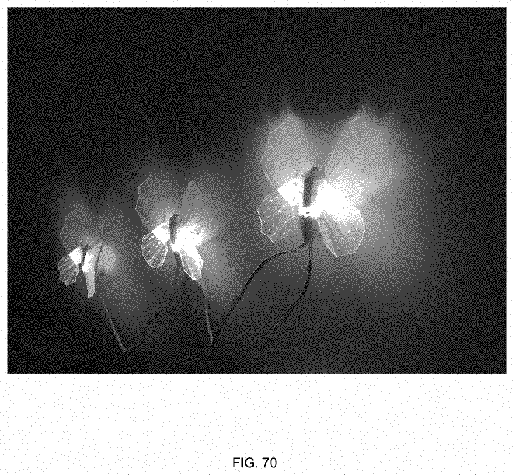

FIGS. 1-70 illustrate various aspects and implementations of STEAM learning kits and interactive devices thereof.

While operations may be depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. A system, device, or method in accordance with the present disclosure.
